(19) United States
(12) Patent Application Publication
(10) Pub. No.: US 2026/0117962 A1
(43) Pub. Date: Apr. 30, 2026

(54) Serial-Parallel Heat-Spreading Circuit

(71) Applicant: DotLight, Inc., Norwalk, CA (US)

(72) Inventor: Tom Paulos, Newport Beach, CA (US)

(21) Appl. No.: 19/371,738

(22) Filed: Oct. 28, 2025

Related U.S. Application Data
(60) Provisional application No. 63/714,065, filed on Oct. 30, 2024.

(51) Int. Cl. F21V 29/71; F21V 23/00; F21Y 105/10; F21Y 115/10

(52) U.S. Cl. CPC F21V 29/71; F21V 23/004; F21Y 2105/10; F21Y 2115/10

(57) ABSTRACT

An electrical circuitry has electrically conductive layers separated by insulators, configured to power surface flip chip or other components mounted on conductive surfaces of the layers in a combined serial / parallel manner. The conductive mounting surfaces can have any combination of components in any variety of configurations, including for example LEDs having different peak wavelengths. One or more of the conductive layers can operate as heat sinks / heat spreaders, and optionally, separated heat spreaders that are thermally coupled with the electrically conductive layers, can be disposed downwardly from the electrically conductive layers.

This application claims priority to US provisional application ser. no. 63/714065 filed October 30, 2024. This and all other referenced extrinsic materials are incorporated herein by reference in their entirety. Where a definition or use of a term in a reference that is incorporated by reference is inconsistent or contrary to the definition of that term provided herein, the definition or use of that term provided herein is deemed to be controlling.

The field of the inventive subject matter is electrical circuits.

### BACKGROUND

The following description includes information that may be useful in understanding the present inventive subject matter. It is not an admission that any of the information provided herein is prior art or relevant to the presently claimed inventive subject matter, or that any publication specifically or implicitly referenced is prior art.

The electronics fabrication industry revolves around placing various electronic components onto circuits. The circuits are generally etched into singular or a plurality of layers on a printed circuit board (PCB), metal core printed circuit boards (MCPCB) boards, ceramic substrates and other functional equivalents. One issue facing electronics design is thermal management. It is common to use a dissipation device, such as a heat sink, for thermal cooling purposes in a circuit assembly. Traditionally, heat sinks are placed in direct contact with a device to prevent device overheating.

The issue of using individual component heat sinks can be overcome by placing the entire PCB on a thermal interface material. The thermal pad, or cold layer, acts as a heat sink, and individual components are on top of the board and heat dissipation paths go through the board to the pad, which is on the underside of the board. However, as the design space for electrical components is shrinking, more components are squeezed into a decreasing amount of space, the space required by all components becomes relevant.

Several years ago, the present inventor addressed these issues in a patent application published as US 2017/0250332, “Heat Dissipation From Circuits Through Quantom Dot Optics And LED Integration”. Although elegant in teaching apparatus and methods for dissipating heat

from closely packed electrical components, the solutions in that application relied strictly on parallel arrangements of components straddling a dielectric disposed between first and second conducting layers. Even where multiple sets of layers were stacked, each of the sets needed to be directly powered. That configuration is problematic because, where power was provided to the various sets through a common bus, a short through any of the powered components in any of the sets could short the entire system.

Thus, there is still a need for a heat dissipating multilayered circuit configured to power multiple electrical components in such manner that a short across any one of the components would not short out all of the layers.

### SUMMARY OF THE INVENTIVE SUBJECT MATTER

The inventive subject matter provides apparatus, systems, and methods in which a heat dissipating circuit comprises electrically conductive layers separated by insulators, configured to power surface contact electronic components in a combined serial / parallel manner, with heat spreaders thermally coupled with, and disposed downward from, couplings between the electronic components and the conductors.

Contemplated components include power transistors, voltage regulators, integrated circuits (ICs), microprocessors and microcontrollers, digital signal processors (DSPs), power diodes, resistors, power resistors, shunt resistors, inductors and transformers, light-emitting diodes (LEDs), thyristors and TRIACs, insulated gate bipolar transistors (IGBTs), power ampliﬁers, audio ampliﬁers, RF power ampliﬁers, capacitors, electrolytic capacitors, switching power supplies and converters, RF components, transmitters and oscillators, laser diodes, heat-generating sensors, infrared emitters, micro-electro-mechanical systems (MEMS devices), and MOSFETs. Components are preferably bipolar devices having two electrodes.

A minimum configuration includes three (3) mounting surface conductors and two (2) insulators, in combination with flip chips or other electronic components to form a series / parallel electrical circuit as in FIG. 1, and heat spreaders thermally coupled with, and disposed downward from, couplings between the electronic components and the conductors.

In this arrangement, multiple electronic components can be coupled in parallel on any given pair of layers separated by an insulator layer, and coupled serially with components on more distant layers. This can be seen in FIG. 8 which shows an embodiment having a series/parallel array where ten strings of components are coupled in series, and the five components in each string coupled in parallel. One should appreciate that a device could have any realistic number of strings, and each of the strings could independently have any realistic number of components.

Flip chip or other components can be conductively joined by solder, wire bond, or any other suitable means to the mounting surface of the conductors. By way of example only, the outer layers can be extended for connection to positive or negative power sources, as needed in a given application, or to become themselves the positive or negative terminals of a power source as seen in FIGS. 1, 2, 3 and 8. In other embodiments, the terminals can take different shapes/sizes and attach to any number of conductors to form positive or negative terminals to allow for a plurality of positive or negative power source connection configurations.

A major advantage of this configuration is that heat produced within components flows directly into the conductors without having to first pass through an insulator as is the case in some device in the current state of the art. Additionally, where the conductors are operating as busbars, the electrically conductive mounting surfaces function as equipotential planar conductors, allowing for the case of one or more components to fail without causing the entire string of series connected components to fail, as the current flowing in the conductive mounting surfaces redistributes between the remaining parallel electrically conductive mounting surfaces. This innovative feature effectively serves to automatically isolate any failed components by redirecting the current (i.e., bypassing the failed component(s) while operating the remaining components in the string).

The conductive mounting surfaces can have any combination of components in any variety of configurations. By way of example only, multiple LEDs can be attached to the conductive mounting surfaces in a plurality of unique configurations within the same complete assembly. The LEDs can be functionally fungible in having the same wavelength emitting characteristics, or they can differ in some manner, as in having different peak wavelengths.

So, for example, a configuration could accommodate different wavelengths from ultraviolet through visible to infrared to meet various design requirements and tuning. This can be seen in FIG. 6 wherein components 152A, 152B, 152C could be UVA LEDs and components 154A, 154B, 154C 650 could be IR LEDs.

Yet another embodiment consists of separate and complete assemblies or sub- assemblies separated by an insulator, to be combined to create electrically addressable strings thereby allowing the power output of each separate string to vary independently of each other. By way of example, separate strings may contain a combination of one or more LEDs with one or a plurality of phosphors providing the option to “tune” the output colors.

Various objects, features, aspects and advantages of the inventive subject matter will become more apparent from the following detailed description of preferred embodiments, along with the accompanying drawing figures in which like numerals represent like components.

The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also as used herein, and unless the context dictates otherwise, the term "coupled to" is intended to include both direct coupling (in which two elements that are coupled to each other contact each other) and indirect coupling (in which at least one additional element is located between the two elements). Therefore, the terms "coupled to" and "coupled with" are used synonymously.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter. Unless a contrary meaning is explicitly stated, all ranges are inclusive of their endpoints, and open-ended ranges are to be interpreted as bounded on the open end by commercially feasible embodiments.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWINGS

FIG. 1 is a perspective view of a heat spreading circuit having 3 layers.

FIG. 2 is a top view of the circuit of FIG. 1.

FIG. 3 is an exploded top view of the circuit of FIG. 1.

FIG. 4 is a transparent top perspective view of a generic prior art flip chip LED.

FIG. 5 is a top view of a component that could be construed as a Flip Chip LED, attached to mounting surface conductors electrically separated by insulator layer.

FIG. 6 is a top view of six LEDs or other components straddling an insulator between anodic and cathodic surfaces.

FIG. 7 is a bottom perspective view of the generic prior art flip chip LED of FIG. 4.

FIG. 8 is a perspective view of a heat spreading circuit having 22 layers

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

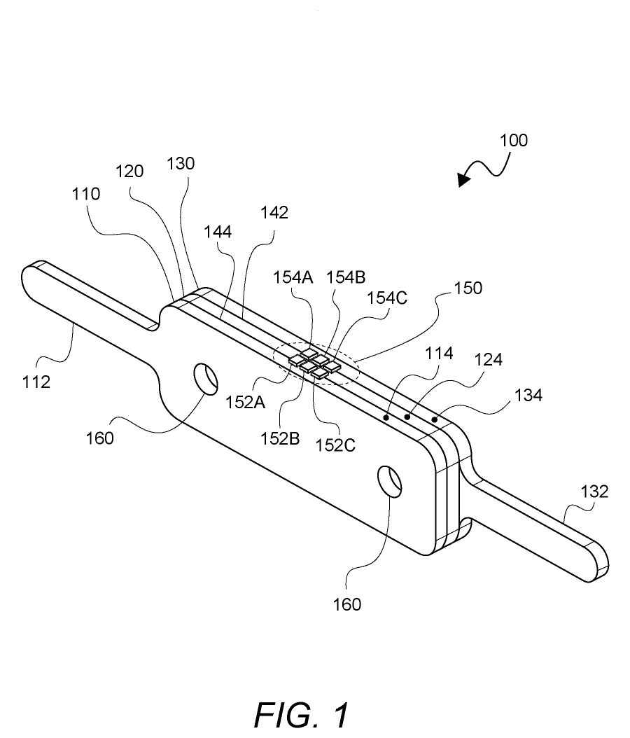

FIG. 1 is a perspective view of a heat spreading circuit 100 having three layers 110, 120, 130 separated by insulators 142, 144. Layers 110, 120, 130 have conducting surfaces 114, 124, 134, respectively. An array 150 of electrical power consuming components includes components 152A, 152B, 152C straddling insulator 142, and components 154A, 154B, 154C straddling insulator 144. Layer 110 has a negative terminal 112 and layer 130 has positive terminal 132.

In this arrangement, current flows from layer 110 through components 152A, 152B, 152C to intermediate layer 120, and then from intermediate layer 120 through components 154A, 154B, 154C to layer 130.

This arrangement has significant advantages in having both serial and parallel current paths. For example, current flows serially from 152A to any of 154A, 154B, 154C, and in

parallel fashion simultaneously across 152A, 152B, 152C, and simultaneously across 154A, 154B, 154C. Accordingly, current interruption across any of the components in array 150 would not preclude current flowing through the other components, and even shorting across any of the components straddling insulator 142 would not affect current flowing through components 154A, 154B, 154C that straddle insulator 144. In addition, the large surface areas of end layers 110 and 130 can readily dissipate heat produced by the components of array 150. This can be especially important where the components of array 150 are high power LEDs.

Layers 110, 120 and 130 can be any suitable electrical conductor, including for example copper, aluminum, or other metal, metal alloy, or metallic substance or substances. Layers 110, 120, and 130 in FIG. 1 should be construed generically as having planar, sinusoidal, or curved in some other manner. Layers 110, 120 and 130 in FIG. 1 should also be construed generically as have flat sides, or ribbed side that facilitate heat dissipation.

Conducting surfaces conducting surfaces 114, 124, 134 are preferably unitary with their respective layers 110, 120 and 130. Thus, if layer 110 is solid copper, then conducting surface 114 could simply be the top side of the solid copper of layer 110. On the other hand, it is contemplated that conducting surfaces 114, 124, 134 can have a different composition from the underlying remainder of their corresponding layers. For example, conducting surfaces 114, 124, 134 can comprise Ni or Au plating. Conducting surfaces 114, 124, 134 are preferably planar, with height variations of less than 3 µm. This co-planarity is configured to cooperate well with flip-chip components. Contemplated thicknesses for preferred insulators 142, 144 generally include thicknesses from 10 to 150 µM. Conductor cross section preferably provides an electrical resistance of less than 1%.

Insulators 142, 144 can comprise any suitable electrically insulating material, including for example ceramic, polymer, glass, diamond, amorphous carbon, composite, or any combination thereof. For small straddling components, the insulators 142, 144 need to be quite thin so that the components can straddle the insulators.

Array 150 is shown in FIG. 1 as having six components, 152A, 152B, 152C straddling insulator 142 and flanking layers 110 and 120, and 154A, 154B, 154C straddling insulator 144 and flanking layers 120, 130. It should be appreciated that many additional components could be

deployed in similar manner, either of the same type (e.g., all LEDs) or of different types (e.g., some LEDs and some RF transmitters). Array 150 can be configured as an assembly or sub-assembly, for example incorporating one or more phosphors and/or one or more quantum dots conﬁgured to emit different colors, thereby enabling a combined light output with adjustable color characteristics.

The extensions 112, 132 of conductors 110, 130, respectively, comprise negative and positive terminals. The terminals could be of different sizes, shapes and configurations. Although the conductive layers act as heat sinks, external heat sinks could be added. By way of example only, optional mounting holes 160 can provide mechanical attachment positions for the purposes of facilitating potential end use applications.

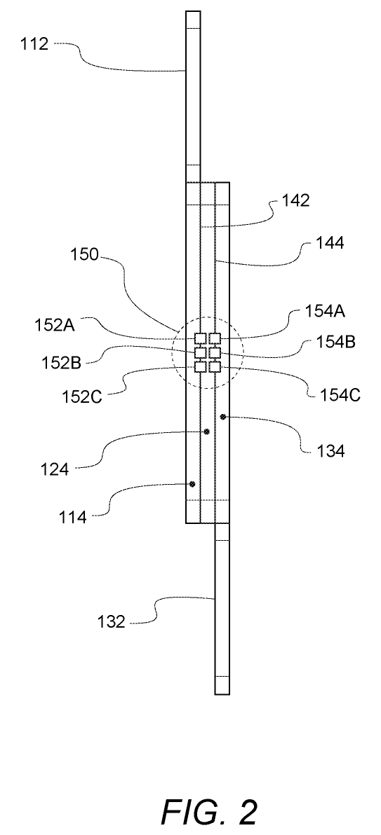

FIG. 2 is a top view of the embodiment of FIG. 1.

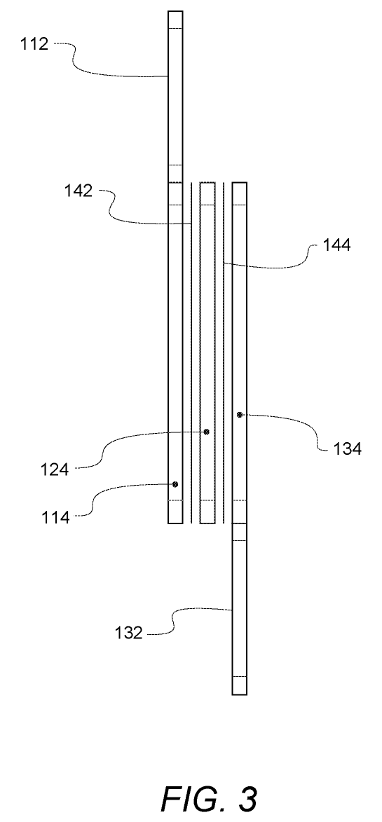

FIG. 3 is an exploded top view of the embodiment of FIG. 1, depicting the three thermally and electrically conductive mounting surfaces 114, 124, 134 separated by insulator 1144 and insulator 2142. Array 150 comprises three parallel electrically connects pairs of two serially electrically connected LEDs or other components. The three parallel electrically connects pairs are such that each mounting surface conductor also functions as an independent equipotential surface.

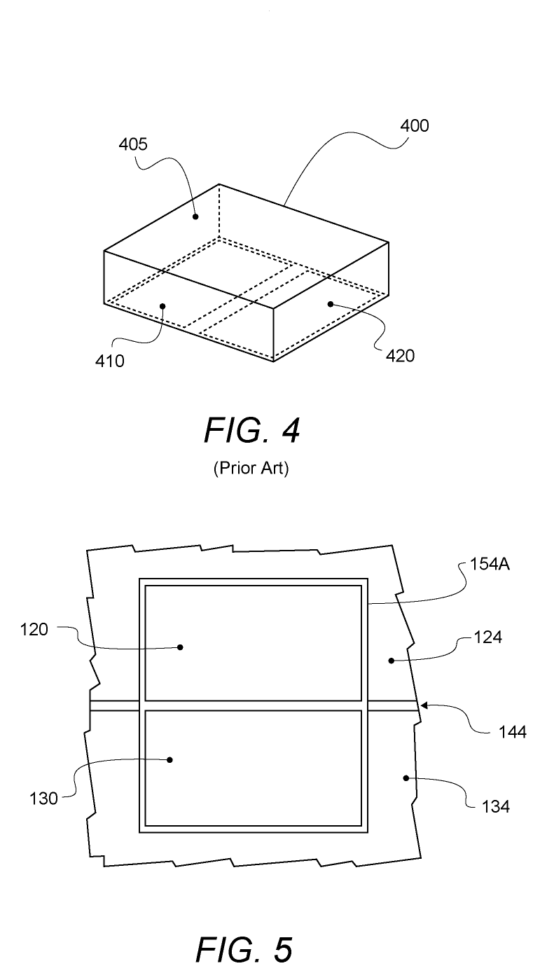

FIG. 4 is a transparent top view of a generic prior art flip chip LED 400 that can be used as any of the conductors 152A, 152B, 152C, 154A, 154B, 154C, wherein the dotted lines represent a single anode 410 and a single cathode 420 both present on the underside bottom of the flip chip.

FIG. 5 is a top view of component 154A, which could be construed as a Flip Chip LED, wherein the anode 410 and cathode 420 are attached to mounting surface conductors 124, 134 electrically separated by insulator layer 144. The electrically separate conductors 120, 130 provide power and heat dissipation for component 154A.

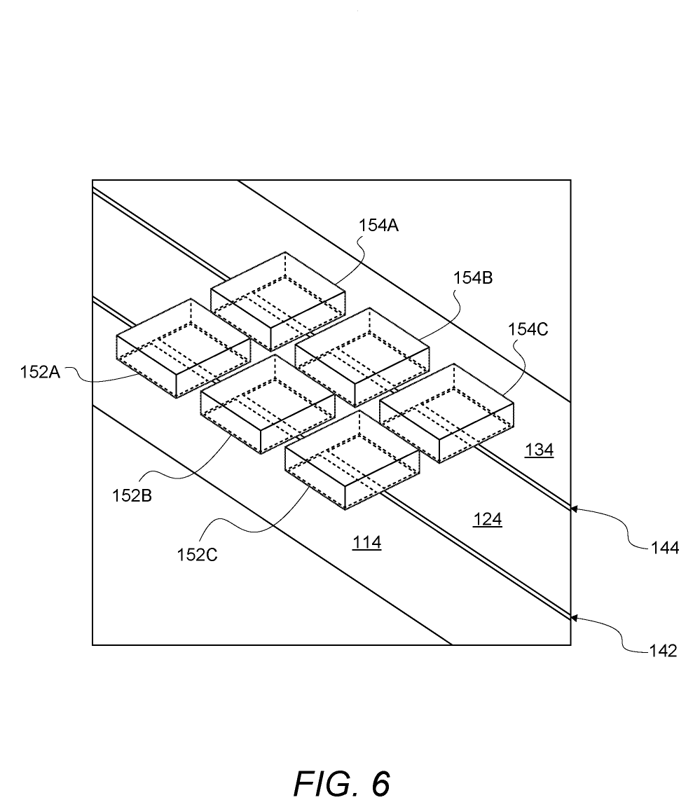

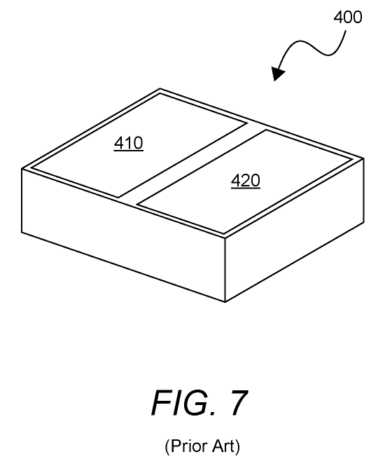

FIG. 6 a top view of six LEDs or other components 152A, 152B, 152C, 154A, 1654B, 154C straddling an insulator between anodic and cathodic surfaces. Components 152A, 152B, 152C are connected in parallel, and each of components 152A, 152B, 152C is connected in

parallel. Also, each of components 152A, 152B, 152C is connected in series with each of components 154A, 154B, 154C.

FIG. 7 is a transparent bottom perspective view of the generic prior art flip chip LED of FIG. 4, showing its respective anode (410) and cathode (420) electrodes.

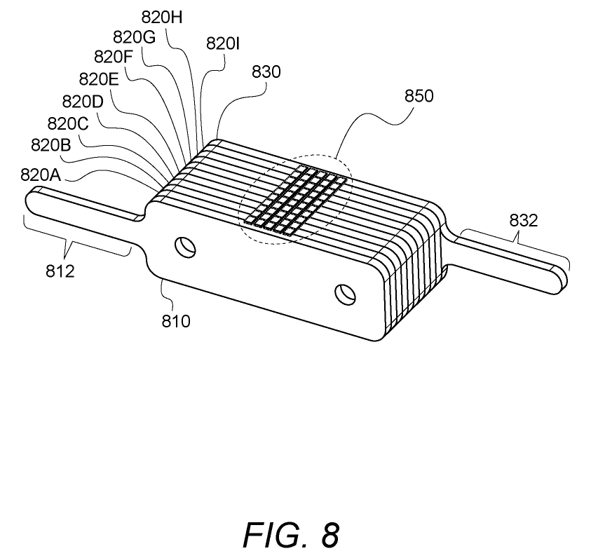

FIG. 8 is a perspective view of a heat spreading circuit having 22 layers, with end conductors 810 and 830 having terminals 812 and 832, respectively, and intermediate conductors 820A – 820I separated by insulators (not numbered). An array 850 of heat LEDs or other heat producing components is arranged on the top surfaces of the conductors in a series/parallel manner.

Regardless of whether there are two layers or more layers. The outer layers are configured as a heat sink by having a side open to the environment.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C …. and N, the text should be interpreted as requiring only one element from the group, not A plus N, or B plus N, etc.

What is claimed is:

1. A heat dissipating electrical circuitry comprising:
first, second, and third electrical conductors;
a first insulator physically disposed between the first and second electrical conductors;
a second insulator physically disposed between the second and third electrical conductors;
each of first and second electronic components electrically coupled between the first and second electrical conductors, and each of third and fourth electronic components electrically coupled between the second and third electrical conductors, such that current is configured to concurrently flow from the first electrical conductor to the third conductor via at each of the first, second, third, and fourth electronic components;
a first heat spreader thermally coupled with, and disposed downward from, a coupling between the first electronic component and the first conductor; and
a second heat spreader distanced from the first heat spreader, and thermally coupled with, and disposed downward from, a coupling between the third electronic component and the third conductor.

2. The electrical circuitry of claim 1, wherein the first heat spreader comprises the first electrical conductor.

3. The electrical circuitry of claim 1, wherein each of the first and second electronic components are mounted directly onto each of the first and second conductors.

4. The electrical circuitry of claim 1, wherein each of the first, second, third, and fourth electronic components comprises a light emitting diode (LED).

5. The electrical circuitry of claim 1, wherein at least one of the first, second, third, and fourth electronic components does not comprise a light emitting diode (LED).

6. The electrical circuitry of claim 1, wherein a voltage is configured to be equipotential the first and second electronic components.

7. The electrical circuitry of claim 1, wherein the coupling comprises a flip chip mounting.

8. The electrical circuitry of claim 1, further comprising:
a fourth electrical conductor;
a third insulator physically disposed between the third and fourth electrical conductors.
each of fifth and sixth electronic components electrically coupled between the third and fourth electrical conductors.

11. An electrical circuitry comprising:
a first string of at least first, second, and third parallel-coupled electronic components, a second string of at least fourth, fifth, and sixth parallel-coupled electronic components;
wherein each of the first string of parallel-coupled electrical components is electrically coupled in series with each of the second string of parallel-coupled electrical components; and
a first heat spreader thermally coupled with, and disposed downward from, a coupling between the first electronic component and the first conductor, and
a second heat spreader distanced from the first heat spreader, and thermally coupled with, and disposed downward from, a coupling between the third electronic component and the third conductor.

12. The electrical circuitry of claim 11, wherein the first string of first parallel-coupled electrical components comprises at least first and second light emitting diodes (LEDs).

13. The electrical circuitry of claim 12, wherein the first and second light emitting diodes are functionally fungible.

14. The electrical circuitry of claim 12, wherein the first and second light emitting diodes are configured to emit light at different peak wavelengths.

15. The electrical circuitry of claim 11, wherein at least one of the first parallel-coupled electrical components is not a light emitting diode (LED) circuitry.

16. The electrical circuitry of claim 11, wherein the first parallel-coupled electronic components are mounted on both a mounting surface of a first electrical conductor and a mounting surface of a second electrical conductor, and the second parallel-coupled electronic components are mounted on the mounting surface of the second electrical conductor and a mounting surface of a third electrical conductor.

17. The electrical circuitry of claim 16, wherein at least one of the first, second, and third electrical conductors comprises a sheet having a height of 0.5mm to 100mm, inclusive.

18. The electrical circuitry of claim 17, wherein the heat spreader comprises the first 0electrical conductor.

19. The electrical circuitry of claim 11, further comprising at least a third string of third parallel-coupled electronic components, wherein each of the third parallel-coupled electrical components is electrically coupled in series with each of the first parallel-coupled electrical components and each of the second parallel-coupled electronic components.

20. A method of dissipating heat from at least first, second, third, and fourth electronic components, comprising:
providing first, second, and third electric conductors;
electrically coupling the first and second electronic components across the first and second electrical conductors;
electrically coupling the third and fourth electronic components across the second and third electrical conductors;
thermally coupling a first heat spreader with a coupling between the first electronic component and the first conductor, and
thermally coupling a second heat spreader distanced from the first heat spreader, and thermally coupled with, and disposed downward from a coupling between the third electronic component and the third conductor.
